(19) United States
(12) Patent Application Publication
(10) Pub. No.: US 2026/0111496 A1
(43) Pub. Date: Apr. 23, 2026

(54) CROSS-EMBEDDING SPACE SEARCH

(71) Applicant: Disney Enterprises, Inc., Burbank, CA (US)

(72) Inventors: Matthew LATHROP, Dallas, TX (US); Erika Varis DOGGETT, Simi Valley, CA (US)

(73) Assignee: Disney Enterprises, Inc., Burbank, CA (US)

(21) Appl. No.: 19/334,644

(22) Filed: Sep. 19, 2025

Related U.S. Application Data
(60) Provisional application No. 63/710,236, filed on Oct. 22, 2024.

(51) Int. Cl. G06F 16/908; G06F 16/901; G06F 16/9038

(52) U.S. Cl. CPC G06F 16/908; G06F 16/9024; G06F 16/9038

(57) ABSTRACT

A method of generating multimodal search results comprising: identifying at least one result asset in a first vector space based on a similarity to a search vector, the at least one result asset having a corresponding representation in a second vector space; identifying at least one second result asset in the second vector space based on a similarity to the representation of the result asset in the second vector space; aggregating the at least one result asset and the at least one second result asset; and providing the at least one result asset and the at least one second result asset to a user as search results.

### CROSS-REFERENCE TO RELATED APPLICATIONS

This application claims the benefit of U.S. Provisional Application No. 63/710,236, filed on Oct. 22, 2024, and entitled “CROSS-EMBEDDING SPACE SEARCH”, the entirety of which is incorporated by reference herein.

### BACKGROUND

Modern asset search systems (for videos, images, audio, or text) increasingly rely on artificial intelligence (AI) to generate “vector embeddings.” In simple terms, an AI model analyzes each asset and encodes its essential features into a high-dimensional mathematical vector, a sort of fingerprint unique to the asset. When a user wants to search for something, the user's query is also converted into a vector in the same space. The search system can then find assets whose vectors are mathematically closest to the query's vector, interpreting the found assets as the best matches.

One challenge with this approach is that these vectors are only interpretable by the specific AI model that created them. Thus, if the organization upgrades to a new AI model (for example, for better accuracy or new features), all assets would need to be reprocessed to create new vectors. As can be appreciated, reprocessing the assets can be costly and time-consuming. Moreover, if an older AI model becomes unavailable, its vectors become useless, as new queries can't be encoded in the space generated by the older AI model. This problem can be even worse when multiple models are used for different types of data (such as video, audio, or metadata) where each model creates its own embedding space, making unified searches across all assets challenging.

Currently, some researchers are trying to address these problems with vector embeddings via utilization of models to produce natural language structured or unstructured data about an asset that can be searched directly. In such cases, an LLM, such as GPT-4v, that is capable of understanding the asset is prompted to return a summary of the asset and the summary is then stored. Users can then search using traditional search technologies over these summaries. Newer models can easily be swapped in because they too are simply producing human readable text that all models can understand.

Converting to natural language, however, necessarily loses some information that is encoded in the vector embedding of the asset. Natural language also requires more space to store than just storing the vectors.

Accordingly, new and improved methods of connecting different embedding search spaces are desired.

### SUMMARY

Embodiments described herein pertain to methods and systems for generating and presenting search results across multiple vector embedding spaces, thereby overcoming the limitations of existing asset search approaches that rely on single-model vector representations or natural language summaries. Embodiments can represent digital assets (such as videos, images, audio, or text) in vector spaces generated by artificial intelligence (AI) models, where each vector encodes essential features of an asset in a high-dimensional mathematical space. Unlike prior approaches that require wholesale reprocessing of all assets when transitioning between AI models or that rely on conversion to natural language summaries, however, embodiments disclosed herein enable search functionality across heterogeneous embedding spaces without loss of fidelity and without extensive reprocessing. In this manner, embodiments provide methods and systems that allow organizations to efficiently search, aggregate, and present results from assets encoded in multiple embedding spaces, regardless of changes to underlying AI models or asset modalities, thereby enabling robust and flexible digital asset management and retrieval.

One aspect of the disclosed embodiments is the use of pairings, which are mappings between representations of the same asset in different vector spaces. By selectively re-encoding a subset of assets in a new AI model, embodiments generate corresponding vector pairs between old and new embedding spaces. These pairings allow for recursive and multi-space search operations. When a user submits a query, assets are identified in a first vector space based on similarity to the query vector. For assets that have corresponding “paired” representations in a second vector space, embodiments can further search in the second space for additional assets similar to the paired representation. The search results from multiple spaces can then be aggregated and presented to the user.

In some embodiments, the pairings between asset representations in different vector spaces are stored in a graph structure, wherein each edge represents a pairing between spaces. This graph-based architecture enables efficient traversal and combination of search results from multiple embedding spaces, accommodating complex queries and diverse asset types.

In some embodiments, the training of a shared embedding space using the paired data is enabled. Vectors from any model-specific space may be translated to the shared space and subsequently into any other model's space, reducing the need for direct pairings between all possible model combinations and facilitating scalable, unified search across evolving AI models. By maintaining the full fidelity of model-generated vector embeddings and enabling interoperability between different AI models and modalities, such embodiments can avoid the information loss and increased storage requirements associated with natural language conversion, while minimizing the need for asset reprocessing thus future-proofing, multimodal asset search across large and diverse digital collections.

According to some embodiments, a method of generating multimodal search results includes: identifying at least one result asset in a first vector space based on a similarity to a search vector, the at least one result asset having a corresponding representation in a second vector space; identifying at least one second result asset in the second vector space based on a similarity to the representation of the result asset in the second vector space; aggregating the at least one result asset and the at least one second result asset; and providing the at least one result asset and the at least one second result asset to a user as search results.

In various implementations, embodiments can include one or more of the following. The corresponding representation of the result asset in the second vector space can be identified using a graph structure that maintains pairings between asset representations in different vector spaces. The mappings between the first and second vector spaces can be maintained in a graph structure, and the method can further include traversing edges of the graph to identify paired representations of assets in additional vector spaces. The identifying and aggregating steps can be performed via recursive traversal of a graph of pairings, enabling multi-stage and multimodal search across arbitrary numbers of vector spaces. The identifying and aggregating steps can be performed in a sequential, stage-wise manner, traversing from the first vector space to the second vector space and optionally to further vector spaces according to a predetermined or dynamically determined progression. The aggregating step can include de-duplicating assets that are identified in multiple vector spaces to ensure each asset is provided only once as a search result. The aggregating step can include ranking the aggregated result assets based on aggregate similarity scores, relevance feedback, or user-defined criteria. Providing the search results to the user can include formatting the results for display via a graphical user interface or an application programming interface, and including metadata associated with each result asset. The at least one result asset and the at least one second result asset can include assets of different modalities.

In various implementations, embodiments can include one or more of: setting a similarity threshold for identifying the at least one result asset in the first vector space where the similarity threshold used to identify the at least one second result asset in the second vector space can be dynamically adjusted based on the similarity between the result asset and the search vector in the first vector space; receiving user feedback on the provided search results and updating the similarity threshold based on the received feedback; translating the search vector and/or asset representations between the first vector space and the second vector space using a shared embedding space generated by artificial intelligence training on paired data; and/or recursively identifying additional result assets in one or more additional vector spaces, each additional vector space having a pairing to a previously identified result asset and aggregating all identified assets across all traversed vector spaces.

In some embodiments a method of generating multimodal search results includes: maintaining a first vector space comprising a plurality of first assets, each first asset encoded by a first artificial intelligence model such that its essential features are represented by a high-dimensional mathematical vector unique to that first asset; maintaining a second vector space comprising a plurality of second assets, each second asset encoded by a second artificial intelligence model, different from the first artificial intelligence model, such that its essential features are represented by a high-dimensional mathematical vector unique to that second asset; receiving a search query and generating a search vector, the search vector being a high-dimensional mathematical vector produced by encoding the search query using the first artificial intelligence model; identifying at least one first result asset in a first vector space based on a similarity between the search vector and the high-dimensional first mathematical vectors representing the first assets in the first vector space; for each identified first asset, determining whether a corresponding second asset exists in the second vector space, the corresponding second asset being associated with the first result asset and represented by a high-dimensional second mathematical vector in the second vector space; identifying at least one second result asset in the second vector space based on a similarity between the high-dimensional second mathematical vector representing the corresponding second asset and the high-dimensional second mathematical vectors representing other second assets in the second vector space; aggregating the at least one first result asset and the at least one second result asset; and providing the at least one result first asset and the at least one second result asset to a user as search results.

In addition to other methods described further below, embodiments of the present disclosure are also directed to systems and devices that can be used to execute such methods. For example, one embodiment is directed to a computer system comprising a processor and a non-transitory computer readable medium coupled to the processor, the non-transitory computer readable medium stores computer instructions that, when executed by the processor, can implement any of the computer-implemented methods described herein.

### BRIEF DESCRIPTION OF THE DRAWINGS

FIG. 1 is a simplified block diagram of a system according to some embodiments;

FIG. 2 is a graphical representation of two different embedding spaces and digital assets mapped therein in accordance with some embodiments;

FIG. 3 is a simplified flowchart of a method according to some embodiments;

FIG. 4 is a simplified flowchart of a method according to some embodiments;

FIG. 5 is a simplified flowchart of a method according to some embodiments; and

FIG. 6 is a simplified block diagram of a computing system in accordance with some embodiments.

### DETAILED DESCRIPTION

As described above, embodiments of the present invention provide methods and systems for searching across multiple vector embedding spaces generated by different artificial intelligence models, enabling unified asset retrieval without requiring wholesale reprocessing or loss of fidelity. By establishing and leveraging pairings between representations of the same asset in different embedding spaces, embodiments both: (i) allow search queries to traverse and aggregate results across these spaces, including through recursive or graph-based approaches, and (ii) further support the creation of a shared embedding space for scalable and future-proof multimodal search. As such, embodiments overcome limitations of previously known techniques by maintaining the full informational richness of AI-generated embeddings, while also reducing processing and storage burdens, and enabling robust search capabilities across evolving models and diverse asset types.

### Example System for Performing Cross-Embedding Space Searches

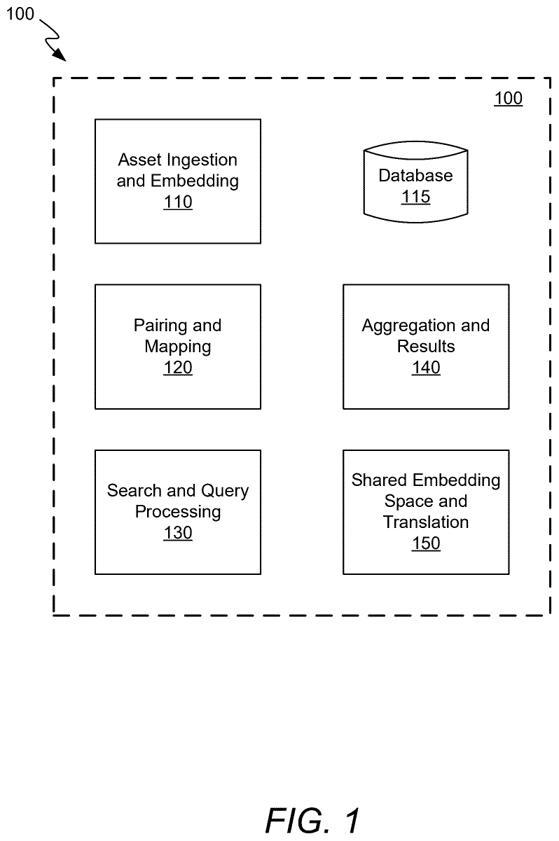

In order to better understand and appreciate embodiments described herein, reference is first made to FIG. 1, which is a simplified block diagram of a system 100 that enables unified search and retrieval of digital assets across multiple vector embedding spaces generated by different artificial intelligence (AI) models according to some embodiments. System 100 can include multiple interconnected subsystems, each of which is configured to perform distinct functions that enable system 100 to conduct unified asset search and retrieval across heterogeneous vector embedding spaces.

As depicted in FIG. 1, system 100 include at least the following core subsystems: asset ingestion and embedding subsystem 110, pairing and mapping subsystem 120, search and query subsystem 130, aggregation and results subsystem 140. In certain embodiments, system 100 can further include an optional shared embedding space and translation subsystem 150. Each of the subsystems 110-150 can be operably interconnected to facilitate the efficient processing, mapping, search, and presentation of multimodal search results, as described in further detail below.

Asset ingestion and embedding subsystem 110 acquires, processes, and encodes digital assets for use in system 100. Subsystem 110 can include various input modules configured to receive digital assets from internal databases, content management systems, user uploads, external sources, and the like. These assets can include, but are not limited to, video files, audio recordings, image files, text documents, and associated metadata.

Upon receiving an asset, subsystem 110 selects one or more artificial intelligence (AI) models, each trained for a specific data modality or optimized for a particular semantic task (e.g., visual content, audio features, textual analysis). Subsystem 110 then applies the selected AI model(s) to generate a high-dimensional vector embedding for the asset. Each embedding serves as a mathematical representation that captures the essential features and semantics of the asset within a model-specific vector space.

In some embodiments, subsystem 110 can implement batch processing pipelines for large-scale ingestion and/or support real-time embedding generation for new or updated assets. The generated embeddings can be stored in a storage systems 115, such as one or more databases, and can be indexed by characteristics, such as asset identifiers, embedding space, model version, and relevant metadata. In some embodiments, subsystem 110 can further maintain a version history of embeddings, allowing for traceability and comparison as AI models evolve.

In some implementations, asset ingestion and embedding subsystem 110 provides an interface for user configuration, enabling administrators to select which AI models are applied to specific asset types, schedule re-encoding operations when new models are introduced, and monitor ingestion pipeline performance. The subsystem can also validate input asset formats, extract and normalize metadata, and generate logs for audit or error tracing.

Users can interact with subsystem 110 directly or indirectly. For instance, content curators or data engineers can upload new assets through a graphical user interface (GUI) or via automated scripts. Subsystem 110 can then provide status updates, embedding generation logs, and error notifications back to users or system administrators, ensuring transparency in asset processing.

Pairing and mapping subsystem 120 maintains relationships between representations of the same asset across different embedding spaces produced by distinct AI models. When an existing asset is re-encoded using a new or updated model, subsystem 120 can establish a pairing between the original embedding and the new embedding, thereby linking the representations across two or more vector spaces.

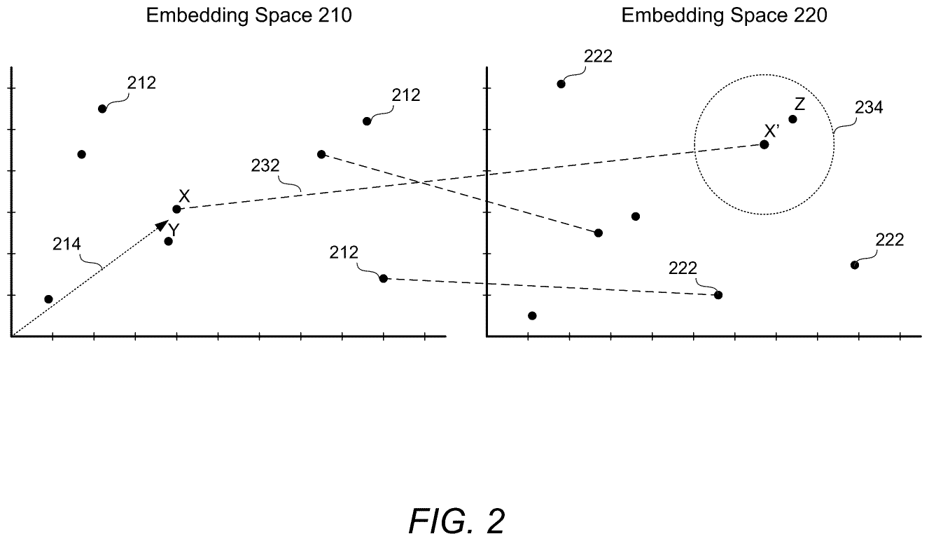

Subsystem 120 can store these pairings in storage systems 115 in, for example, a mapping database, which can be implemented as a relational database, a key-value store, or a graph database. In embodiments where pairings are stored in a graphs, each node can represent a specific asset embedding (uniquely identified by asset and model/version), and each edge can represent a pairing (i.e., the fact that two embeddings correspond to the same underlying asset in different spaces). This structure, discussed in more detail below in conjunction with FIG. 2, facilitates efficient traversal and supports recursive queries across embedding spaces.

Subsystem 120 can include algorithms for verifying pairing integrity, such as by checking asset identifiers, hash-based content signatures, or metadata congruence. In some embodiments, subsystem 120 can support partial or probabilistic pairings, for example, when only a subset of assets is re-encoded during a model upgrade. Some embodiments can also support automated detection and resolution of mapping conflicts or inconsistencies.

Pairing and mapping subsystem 120 can expose an application programming interface (API) or internal service endpoint for use by other subsystems, particularly search and query subsystem 130. Through this API, subsystem 130 can request pairings for a given embedding or traverse the mapping graph to identify related embeddings in other spaces. Subsystem 120 can also log mapping operations and support administrative queries for mapping status, coverage, and gap analysis.

From a user perspective, administrators may interact with pairing and mapping subsystem 120 to review or manually curate mappings, especially in cases where automated pairing fails or requires domain expertise. In some embodiments, subsystem 120 can provide visualization tools showing the graph of pairings and the coverage of embeddings across models, aiding in system maintenance and upgrade planning.

Search and query subsystem 130 processes user search queries and orchestrates similarity search operations across one or more embedding spaces. To facilitate such, subsystem 130 can include interfaces for receiving search input, such as a keyword, phrase, natural language query, or even an example asset (e.g., a reference image or audio clip).

Upon receiving a query, subsystem 130 can encode the query into one or more vector representations using the relevant AI model(s). For example, if a user is searching for a video, the query can be embedded into the video embedding space; for multimodal queries, the query can be simultaneously embedded in several spaces. Subsystem 130 can then perform similarity search operations in the initial embedding space, using algorithms such as approximate nearest neighbor (ANN) search, cosine similarity, or other vector distance metrics, to identify assets most similar to the query vector.

For assets found in the initial search that have pairings to one or more other embedding spaces (as determined by querying subsystem 120), subsystem 130 can initiate additional searches in the corresponding spaces. To illustrate, reference is made to FIG. 2, which graphically depicts two different embedding spaces: embedding space 210 and embedding space 220.

As shown in FIG. 2, embedding space 210 includes multiple encoded digital assets 212 and embedding space 220 includes multiple encoded digital assets 222. A user's query in embedding space 210 (represented by arrow 214) identifies two digital assets 212 (labeled as X and Y) in embedding space 210 as a close match. In the depicted example, asset X has a paired digital asset 222 (labeled as X′) in embedding space 220 as illustrated graphically by edge 232 while asset Y does not have a paired asset. Subsystem 130 can thus return X′ as a matching digital asset. Subsystem 130 can also search for additional matching digital assets in embedding space 220 similar to X′ (represented by search area 234, which as shown in the example depicted in FIG. 2, can also identify a second digital asset 222 (labeled as Z). In this manner subsystem 130 can potentially identify assets not directly accessible in the initial space thus enabling recursive, multimodal, and cross-space search strategies.

In some embodiments, search and query subsystem 130 can implement query expansion, result weighting, and relevance feedback mechanisms to refine search accuracy. In some embodiments, subsystem 130 can support advanced queries, such as searching for assets similar to a set of examples, or multi-stage queries that traverse several embedding spaces using the pairing graph maintained by subsystem 120. The subsystem can also support user-configurable search parameters, including modality selection, relevance thresholds, or search depth (number of recursive traversals).

In some implementations, users can interact with subsystem 130 through a user-facing search interface, which can be web-based, integrated into an asset management platform, or exposed via an API. The interface can allow users to submit queries, select search options, and view or refine results. In some implementations, subsystem 130 can also provide real-time query suggestions, display search progress, and allow users to interactively explore related assets across different modalities or embedding spaces.

Aggregation and results subsystem 140 is configured to collect, consolidate, and present search results obtained from multiple embedding spaces. Upon receiving candidate results from search and query subsystem 130, subsystem 140 aggregates the assets, de-duplicates overlapping results (i.e., the same asset found in multiple spaces), and ranks the results according to relevance scores, user-defined criteria, or a combination thereof. In various embodiments, subsystem 140 can support result merging strategies, such as prioritizing assets with the highest aggregate similarity across spaces, or weighting results based on user preferences or asset metadata (e.g., recency, popularity, modality). Aggregation logic can also include filtering steps to exclude assets that fail to meet certain thresholds or constraints.

Aggregation and results subsystem 140 can format the unified result set for presentation to a user. This can include generating result cards or lists that display asset thumbnails, titles, metadata, and links to source embeddings or associated files. In some embodiments the subsystem can also provide interactive features, such as result preview, relevance feedback (e.g., thumbs up/down, star ratings), and result export or sharing capabilities.

Subsystem 140 can integrate with user interface components to enable seamless delivery of results, including support for pagination, infinite scroll, or faceted browsing. The subsystem can provide analytics on search performance, such as result diversity, coverage of modalities, and user engagement metrics.

From a user perspective, aggregation and results subsystem 140 can be the primary touchpoint for reviewing and interacting with search results. Users can sort, filter, and explore results, request additional details or related assets, and provide feedback to refine future search operations. The subsystem can also allow users to bookmark, annotate, or organize found assets for downstream workflows.

In certain embodiments, system 100 can further include shared embedding space and translation subsystem 150, which can provide advanced translation and integration capabilities between model-specific embedding spaces. For example, subsystem 150 can be configured to use the paired embeddings maintained by subsystem 120 to train a translation model, such as a neural network or linear mapping, capable of projecting vectors from any individual space to a shared, model-agnostic embedding space, and vice versa. In this manner, shared embedding space can act as a universal intermediary, enabling assets and queries from disparate model spaces to be compared, searched, or ranked using a common mathematical framework. Subsystem 150 can also support direct translation between two specific embedding spaces via the shared space, eliminating the need for a direct pairing between every possible model combination.

Subsystem 150 can manage training workflows, including selection of training data (paired embeddings), training of translation models, validation of mapping accuracy, and deployment of translation services. The subsystem can update translation models as new pairings are established or as new embedding spaces are added to system 100.

In some implementations, search and query subsystem 130 can invoke subsystem 150 to translate query vectors or asset embeddings as needed. For example, if a user submits a query in a space that does not directly cover a desired modality, the query vector can be projected to the shared space and then into the target space, enabling seamless cross-modal or cross-model retrieval.

Having described an architecture of and functional roles of a system and its various subsystems according to some embodiments, the following sections describe exemplary methods by which system 100 can execute cross-embedding space search operations. In various embodiments, system 100 can implement any of several distinct query execution processes, including a graph-based pairing traversal, a sequential threshold-driven traversal, and a shared embedding space approach enabled via AI training. Each of these processes leverages the capabilities and data structures provided by system 100 and the aforementioned subsystems to facilitate robust, multimodal asset search across heterogeneous embedding spaces as detailed below.

### Graph-Based Pairing Traversal

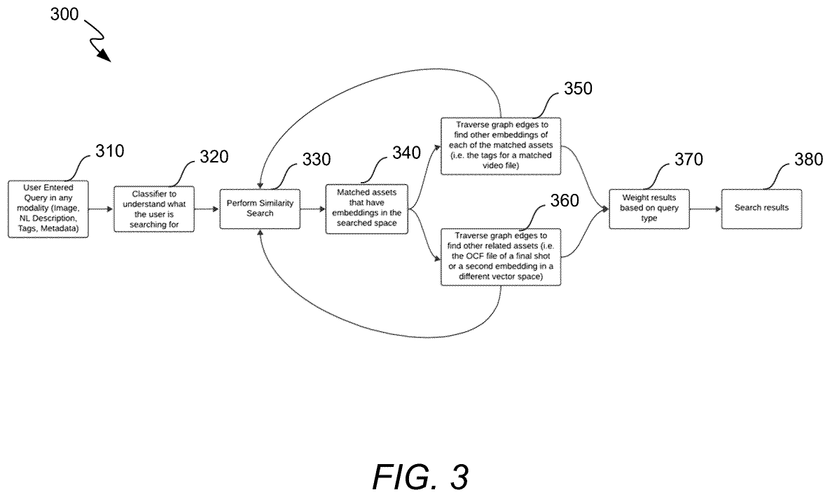

FIG. 3 illustrates an exemplary query execution method 300 for traversing multiple vector embedding spaces in accordance with some embodiments in which the relationships between asset embeddings in different vector spaces are organized as a graph (i.e., nodes and edges). In the graph, each node is an embedding of an asset in a specific space, and each edge represents a pairing (i.e., the same asset encoded in two different spaces). As shown, method 300 begins with a user submitting a search query (block 310). The search query can be submitted in any appropriate manner including, for example, via a graphical user interface (GUI), via application programming interface (API), or other suitable input mechanism. The search query can include a textual request, one or more keywords, or exemplar asset.

Method 300 then reads and interprets the search query and generates a search vector based on the received search request (block 320). The search vector can be generated by encoding the search query using a selected artificial intelligence (AI) model thereby producing a query vector that is compatible with a first vector embedding space. The search vector serves as the initial mathematical representation of the user's search intent.

Once the search vector is generated, method 300 can perform a similarity search to identify one or more result assets in the first vector embedding space based on similarity to the search vector (block 330). Similarity can be determined using any suitable algorithm or set of metrics, such as cosine similarity, Euclidean distance, or the like.

Matched assets in the search space are then identified and designated as the result assets (block 340). The result assets can be determined by, for example, identifying assets in the search space that exceed a predetermined similarity threshold with the search vector.

Next, method 300 can determine whether the result assets identified in the searched vector embedding space have corresponding representations, or “pairings,” in a second, different embedding space generated by a different AI model (block 350). These determinations can be made by referencing a graph structure that maintains relationships between asset embeddings across multiple vector spaces (for example, by traversing graph edges that link the identified asset in the current search space to other assets in a second embedding space). For each result asset that has a paired representation in a different vector embedding space, block 350 retrieves the corresponding paired asset vector.

In conjunction with identifying other embeddings of the same asset in other spaces (block 350), embodiments can also traverse the graph edges to conduct a secondary similarity search to find other related assets in other vector spaces that are similar to, but not a direct pair with, the results assets (block 360). That is, as described above with respect to FIG. 2, block 350 can find embeddings that are direct pairs of the results asset, such as digital asset X′, while block 360 can find embeddings of related digital assets found by similarity with the results asset, such as digital asset Z.

As indicated in FIG. 3, the search steps in blocks 330-360 can be recursively repeated for further embedding spaces. That is, assets discovered in the second space may themselves have pairings in a third space, allowing the system to continue traversing the mapping graph and performing additional searches as needed. This recursive traversal enables the aggregation of a comprehensive set of results reflecting the underlying digital asset collection, regardless of the encoding models utilized.

Once the searches from blocks 330-360 are finalized, method 300 aggregates the results obtained from all the traversed embedding spaces (block 370). The aggregation logic can include, for example, de-duplication of assets, ranking of assets based on aggregate similarity scores or user-defined criteria, and/or formatting results for user presentation.

Finally, at block 380, the unified set of search results can be provided to the user, typically via a GUI or API, enabling the user to review, filter, and interact with the discovered assets.

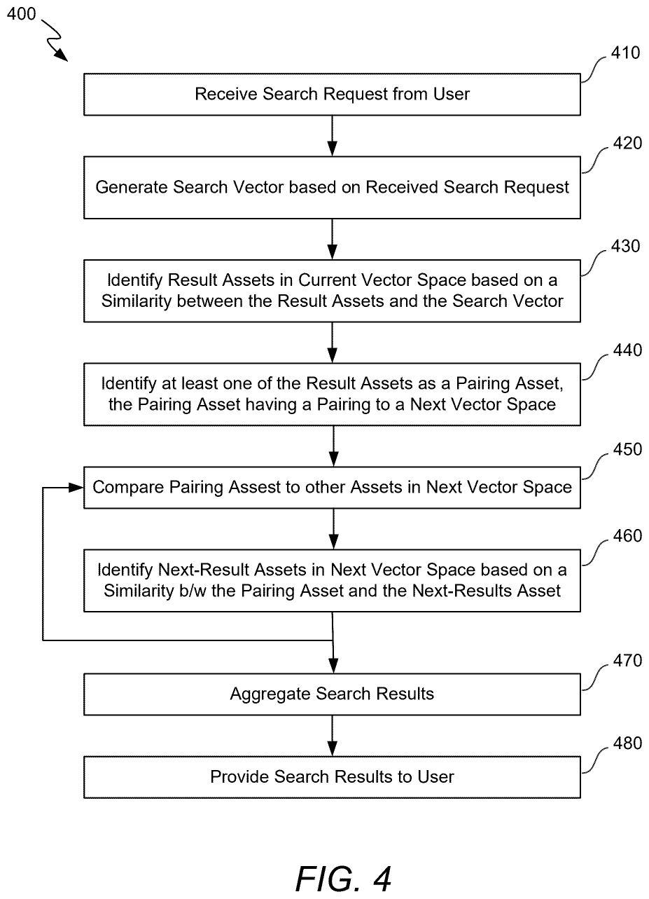

While the graph-based recursive traversal described above offers flexibility and scalability, alternative embodiments can employ a more structured, stage-wise approach to cross-embedding space search, with explicit handling of similarity thresholds and aggregation steps. FIG. 4 illustrates such an embodiment, as described below.

### Sequential, Threshold-Driven Traversal

Turning now to FIG. 4, which is a simplified flowchart of a method 400 for performing a cross-embedding space search according to some embodiments in which a linear, stage-wise order to the traversal of embedding spaces is performed. Method 400 can proceed through a sequence of spaces, typically predetermined or dynamically selected, using explicit similarity thresholds to determine which assets advance to each next stage.

As shown in FIG. 4, method 400 can start when the system (e.g., system 100) receives a user query (block 410). A search vector can then be generated based on the received request (block 420). Method 400 can then identify result assets in a first vector space (e.g., vector space 210) based on similarity to the search vector (block 430), selecting those assets that exceed a predetermined similarity threshold.

Next, method 400 determines whether any of the result assets identified in block 430 have a corresponding representation (i.e., a paired asset) in a second vector space, such as vector space 220 (block 440). If a paired asset exists, method 400 then compares the pairing asset in the second vector space to other assets within that space using a similarity threshold, or similar technique (block 460). In some embodiments, method 400 allows the similarity threshold to be dynamically adjusted (for example, as the similarity between the initial result asset and the search vector decreases, a higher similarity may be required in subsequent spaces).

The process may continue into additional vector spaces by recursively repeating the pairing and comparison steps until no further pairings are found or a maximum number of spaces has been traversed. Once all desired result assets have been identified, the system aggregates the results (block 470), ensuring each asset is provided only once, and presents the unified set to the user (block 480).

Thus, as an illustrative example, in one implementation method 400 can conduct a search in space A, find assets above a predetermined threshold, and then check for those assets in space B. After checking in space B, method 400 can continue to search for assets in space C. The searches in method 400 from space A to space B to space C are performed in an ordered, step-by-step manner, providing enhanced control over cross-space search quality via explicit thresholding, and a predictable, stage-wise progression through embedding spaces.

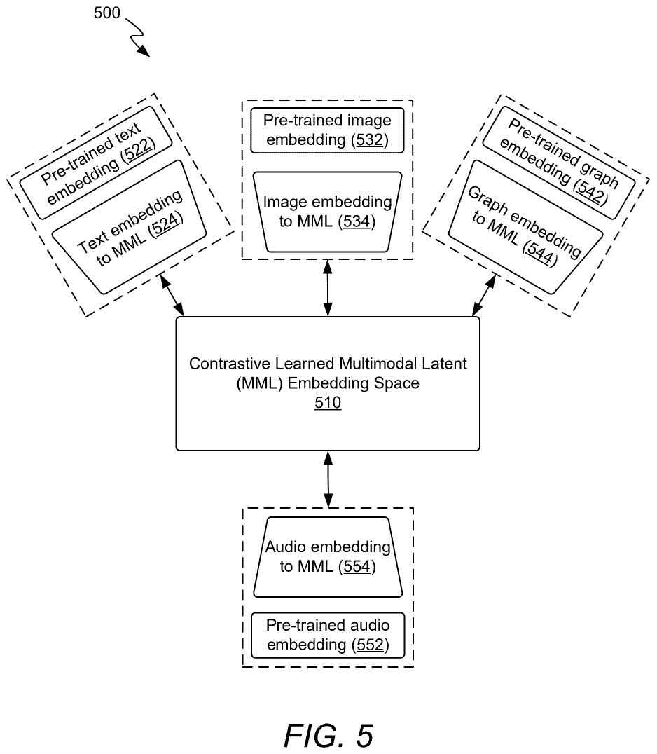

In addition to the graph-based and sequential threshold-driven approaches described above, further embodiments may employ AI-based techniques to construct a shared embedding space, facilitating translation between diverse model-specific spaces and enabling scalable, multimodal search. FIG. 5 illustrates such an embodiment.

### Shared Embedding Space Via AI Training

FIG. 5 is a simplified block diagram depicting an architecture of a system 500 that employs AI-based techniques to construct a shared embedding space 510 in which vectors from multiple different model-specific spaces can be translated to a shared space and subsequently into any other of the model's spaces. Shared embedding space 510 is a shared multimodal latent embedding space and is sometimes referred to herein as “MML embedding space 510” for short. MML embedding space 510 can be generated by collecting paired representations of assets across multiple embedding spaces. Using these pairings, system 500 can train a model, such as a neural network, using techniques such as contrastive learning or similar techniques and trained to minimize the distance between embeddings of paired assets from the different modalities supported by system 500 and to maximize the distance between unrelated pairs. As a result, embeddings from any supported modality, once mapped into MML embedding space 510, can be directly compared using standard similarity metrics (such as cosine similarity, Euclidean distance or Jaccard similarity), enabling unified cross-modal retrieval and search.

System 500 can include multiple distinct embedding spaces, each with its own model-specific encoder and its own translator, that can interact with the shared embedding space 510. Each encoder can generate a high-dimensional vector that captures the semantic features of assets into the encoder in a manner that is specific to the architecture and training data of the original embedding model. The translator can then translate vectors encoded by the encoder into the shared vector space 510.

As depicted in FIG. 5, system 500 allows searches and translations between four separate embedding spaces: one for text, one for images, one for graphs and one for audio. System 500 can initially process assets for each distinct embedding space with a pre-trained, model-specific embedding function. Specifically, a pre-trained text encoder 522 receives a text asset and encodes it into a high-dimensional vector representation that captures the semantic meaning of the text, a pre-trained image encoder 532 receives an image asset and encodes it into a high-dimensional vector representation that captures the semantic meaning of the image, a pre-trained graph encoder 542 receives a graph asset and encodes it into a high-dimensional vector representation that captures the semantic meaning of the graph, and a pre-trained audio encoder 552 receives an audio asset and encodes it into a high-dimensional vector representation that captures the semantic meaning of the audio asset. Each of the four embeddings is unique to the particular AI model used and resides in a model-specific vector space.

The output of each pre-trained encoder is then provided to a respective translator, which performs a transformation of the model-specific embedding into the multimodal latent space 510. Thus, as depicted, the output of text encoder 522 is provided to a translator 524 labeled “Text embedding to MML” in FIG. 5, the output of image encoder 532 is provided to a translator 534 labeled “Image embedding to MML”, the output of graph encoder 542 is provided to a translator 544 labeled “Graph embedding to MML”, and the output of audio encoder 552 is provided to a translator 554 labeled “Audio embedding to MML”.

In certain embodiments, this transformation is accomplished using a neural network or other machine learning model trained on paired data consisting of the type of embedded asset (text, image, graph or audio) and other modalities. The transformation function can be learned such that embeddings of a particular asset, when mapped into the MML space, are aligned with corresponding embeddings from other modalities (e.g., text embedding can be aligned with image, audio and graph embeddings) that represent semantically similar content.

In operation, assets of the different types of embeddings supported by system 500 (text, image, audio, graph) are each encoded by their respective pre-trained embedding models and then transformed into the MML space by their corresponding mapping functions. User queries, regardless of modality, are processed in the same manner, allowing the system to identify and retrieve assets from any modality that are most similar to the query vector in the MML space. The results can then be aggregated and presented to the user as a unified result set.

The architecture of system 500 eliminates the need for direct pairings between every possible pair of original embedding spaces and instead relies on the shared MML space as a universal reference for similarity-based search across all supported modalities.

### Computer System

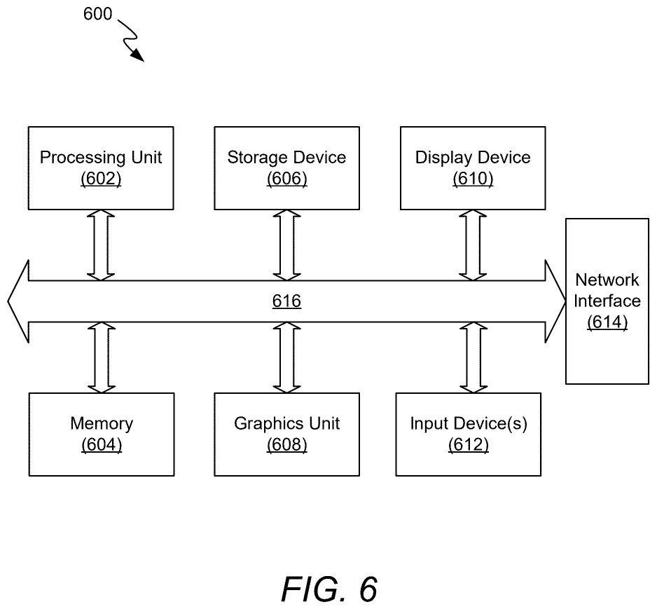

The methods and systems described herein, including those for performing cross-embedding space searches as disclosed in this application, may be implemented on a variety of computer systems suitable. Such systems may include, but are not limited to, desktop computers, workstations, servers, cloud-based computing environments, or specialized graphics appliances. Referring now to FIG. 6, an exemplary computer system 600 for performing cross-embedding space searches is illustrated and described below.

Computer system 600 generally includes at least one processor 602, a memory 604, one or more storage devices 606, an optional graphics processing unit (GPU) 608, a display device 610, one or more input devices 612, and one or more network interfaces 614. These components can be interconnected via a bus or other suitable communication infrastructure 616.

Processor(s) 602 can include one or more central processing units (CPUs), microprocessors, multi-core processors, or combinations thereof. The processor(s) are configured to execute program instructions to perform the steps of the processing methods disclosed herein. Memory 604 can include volatile memory (e.g., random access memory (RAM)), non-volatile memory (e.g., flash, ROM), or combinations thereof. The memory stores program instructions and data that are accessed by the processor(s) during execution of graphics processing tasks.

The one or more storage devices 606 can include hard disk drives (HDDs), solid-state drives (SSDs), optical storage, or other persistent storage media. Storage devices 606 can contain operating system software, application software, graphics libraries, neural network weights, image datasets, and other resources required for graphics processing. Graphics Processing Unit (GPU) 608 can be a specialized hardware component optimized for parallel processing of graphics and image data.

Display device 610 can include one or more monitors, projectors, virtual reality (VR) headsets, or other devices suitable for presenting visual output generated by the system. Input Devices 612 can be keyboards, mice, touchscreens, digitizer tablets, voice input, and/or other user interface devices. Input devices 612 can also include specialized sensors, such as cameras, depth sensors, or motion capture devices, for acquiring data used in graphics processing or avatar creation.

Network interfaces 614 enable communication with other computer systems or devices over a wired or wireless network too allows for distributed or cloud-based processing, remote data acquisition, or collaborative graphics workflows. The bus or communication infrastructure 616 can interconnect all of the above components of system 600 and supports the transfer of data and control signals between them.

Computer system 600 can execute an operating system (e.g., Windows®, macOS®, Linux®), as well as graphics processing software, application-specific modules, and libraries for 3D modeling, rendering, and machine learning (e.g., OpenGL®, Vulkan®, Direct3D®, TensorFlow®, PyTorch®). Program instructions for implementing the methods described herein can be stored in the memory 604 or storage device 606 and executed by the processor(s) 602 and/or GPU 608. Such instructions can be embodied as software modules, plug-ins, or as part of a larger graphics application or pipeline.

In some embodiments, computer system 600 can be part of a distributed computing environment or cloud infrastructure. For example, graphics processing and neural network training may be performed on a cluster of networked servers or in a cloud-based GPU instance, with data and results transmitted to and from client devices via the network interfaces 614.

It will be understood that the configuration of computer system 600 is illustrative and not limiting. In various embodiments, system 600 can include additional hardware components (e.g., FPGAs, ASICs), omit certain components, or be integrated into a mobile device, embedded system, or dedicated appliance. The described methods can be implemented in hardware, software, firmware, or any combination thereof.

### Additional Embodiments

For purposes of explanation, the foregoing description used specific nomenclature to provide a thorough understanding of the described embodiments. However, it will be apparent to one skilled in the art that some specific details are not required in order to practice the described embodiments. For example, the specific subsystems of system 100 described above are identified for illustrative purposes. In other embodiments, the described functions can be performed by a greater or fewer number of subsystems or can be otherwise allocated or combined among the subsystems differently than described without departing from the scope of the invention. Additionally, while not explicitly described the various subsystems of system 100 can be implemented in software, hardware, or firmware modules, or a combination of such. As another example, system 500 is depicted in FIG. 5 as including encoders and translators for four separate embedding spaces. The depicted spaces are for illustrative purposes only, and a person of skill in the art will appreciate that in other implementations, system 500 can include more or fewer than four embedding spaces. Thus, the foregoing descriptions of the specific embodiments described herein are presented for purposes of illustration and description. They are not intended to be exhaustive or to limit the embodiments to the precise forms or implementations disclosed.

Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

What is claimed is:

1. A method of generating multimodal search results, the method comprising:
identifying at least one result asset in a first vector space based on a similarity to a search vector, the at least one result asset having a corresponding representation in a second vector space;
identifying at least one second result asset in the second vector space based on a similarity to the representation of the result asset in the second vector space;
aggregating the at least one result asset and the at least one second result asset; and
providing the at least one result asset and the at least one second result asset to a user as search results.

2. The method of claim 1, wherein the corresponding representation of the result asset in the second vector space is identified using a graph structure that maintains pairings between asset representations in different vector spaces.

3. The method of claim 2, wherein mappings between the first and second vector spaces are maintained in a graph structure, and the method further comprises traversing edges of the graph to identify paired representations of assets in additional vector spaces.

4. The method of claim 2, wherein the identifying and aggregating steps are performed via recursive traversal of a graph of pairings, enabling multi-stage and multimodal search across arbitrary numbers of vector spaces.

5. The method of claim 1, further comprising setting a similarity threshold for identifying the at least one result asset in the first vector space.

6. The method of claim 5, wherein the similarity threshold used to identify the at least one second result asset in the second vector space is dynamically adjusted based on the similarity between the result asset and the search vector in the first vector space.

7. The method of claim 5, further comprising receiving user feedback on the provided search results and updating the similarity threshold based on the received feedback.

8. The method of claim 1, wherein the identifying and aggregating steps are performed in a sequential, stage-wise manner, traversing from the first vector space to the second vector space and optionally to further vector spaces according to a predetermined or dynamically determined progression.

9. The method of claim 1, further comprising translating the search vector and/or asset representations between the first vector space and the second vector space using a shared embedding space generated by artificial intelligence training on paired data.

10. The method of claim 1, further comprising recursively identifying additional result assets in one or more additional vector spaces, each additional vector space having a pairing to a previously identified result asset and aggregating all identified assets across all traversed vector spaces.

11. The method of claim 1, wherein the aggregating step comprises de-duplicating assets that are identified in multiple vector spaces to ensure each asset is provided only once as a search result.

12. The method of claim 1, wherein the aggregating step further comprises ranking the aggregated result assets based on aggregate similarity scores, relevance feedback, or user-defined criteria.

13. The method of claim 1, wherein providing the search results to the user comprises formatting the results for display via a graphical user interface or an application programming interface, and including metadata associated with each result asset.

14. The method of claim 1, wherein the at least one result asset and the at least one second result asset comprise assets of different modalities.

15. A method of generating multimodal search results, the method comprising:
maintaining a first vector space comprising a plurality of first assets, each first asset encoded by a first artificial intelligence model such that its essential features are represented by a high-dimensional mathematical vector unique to that first asset;
maintaining a second vector space comprising a plurality of second assets, each second asset encoded by a second artificial intelligence model, different from the first artificial intelligence model, such that its essential features are represented by a high-dimensional mathematical vector unique to that second asset;
receiving a search query and generating a search vector, the search vector being a high-dimensional mathematical vector produced by encoding the search query using the first artificial intelligence model;
identifying at least one first result asset in a first vector space based on a similarity between the search vector and the high-dimensional first mathematical vectors representing the first assets in the first vector space;
for each identified first asset, determining whether a corresponding second asset exists in the second vector space, the corresponding second asset being associated with the first result asset and represented by a high-dimensional second mathematical vector in the second vector space;
identifying at least one second result asset in the second vector space based on a similarity between the high-dimensional second mathematical vector representing the corresponding second asset and the high-dimensional second mathematical vectors representing other second assets in the second vector space;
aggregating the at least one first result asset and the at least one second result asset; and
providing the at least one result first asset and the at least one second result asset to a user as search results.

16. The method of claim 15, wherein an association between each identified first result asset and its corresponding second asset is maintained in a graph data structure, the graph comprising nodes representing assets and edges representing pairings between assets in different vector spaces, and wherein determining whether a corresponding second asset exists in the second vector space comprises traversing the edges of the graph.

17. The method of claim 15, further comprising, for the step of identifying at least one first result asset in the first vector space, applying a similarity threshold such that only first assets having a similarity score to the search vector greater than or equal to the threshold are identified as first result assets, and wherein the similarity threshold is dynamically adjusted for identifying second result assets in the second vector space based on the similarity score between the search vector and the first result asset.

18. The method of claim 15, wherein the step of determining whether a corresponding second asset exists in the second vector space comprises translating the high-dimensional first mathematical vector representing the first result asset into a shared multimodal embedding space generated by a machine learning model trained using paired data from the first and second vector spaces, and identifying the corresponding second asset based on proximity in the shared embedding space.

19. The method of claim 15, wherein aggregating the at least one first result asset and the at least one second result asset comprises de-duplicating assets that are identified in both the first and second vector spaces, and ranking the aggregated assets based on composite similarity scores or user-defined relevance criteria.

20. The method of claim 15, wherein providing the at least one first result asset and the at least one second result asset to the user as search results comprises formatting the results for display via a graphical user interface, the formatted results including metadata associated with each result asset and enabling user feedback for refinement of future search operations.
